(19) United States
(12) Patent Application Publication
(10) Pub. No.: US 2024/0220805 A1
(43) Pub. Date: Jul. 4, 2024

(54) GENERATING TRAINING DATA FOR BUNDLE SCORING MACHINE-LEARNING MODEL BASED ON CONTENT SELECTION MODELS

(71) Applicant: Maplebear Inc., San Francisco, CA (US)

(72) Inventors: Jonathan Gu, San Francisco, CA (US); Bo Xiao, Hillsborough, CA (US); Yixi Ouyang, Milpitas, CA (US); Jennifer Wiersema, Oakland, CA (US); Sophia Li, San Francisco, CA (US); Matias Cersosimo, Stanford, CA (US); Rustin Partow, San Francisco, CA (US); Levi Boxell, Brownsburg, IN (US); Tilman Drerup, Palo Alto, CA (US); Oleksii Stepanian, San Francisco, CA (US)

(21) Appl. No.: 18/393,338

(22) Filed: Dec. 21, 2023

Related U.S. Application Data
(60) Provisional application No. 63/478,138, filed on Dec. 31, 2022.

(51) Int. Cl. G06N 3/084

(52) U.S. Cl. CPC G06N 3/084

(57) ABSTRACT

A system accesses user data describing characteristics of a user and generates a content item score for each content item of a plurality of content items. The system generates the content item score by applying a machine-learning model to the user data, and then generates a plurality of content bundles. The system also generates a bundle score for each content bundle based on corresponding content item scores for the content item associated with each content bundle, randomly selects a bundle of the plurality of content bundles based on the generated bundle scores, and transmits the randomly selected bundle to a client device associated with the user for display to the user. Finally, the system applies the model to each of the generated training examples and updates the parameters of the model based on the model output.

### CROSS REFERENCE TO RELATED APPLICATION

This application claims the benefit of U.S. Provisional Application No. 63/478,138, filed Dec. 31, 2022, which is incorporated by reference in its entirety.

This application also incorporates by reference the following applications:

Commonly owned U.S. Application No. XX/XXX,XXX, entitled “Counterfactual Policy Evaluation of Model Performance,” and filed on Dec. 21, 2023.

Commonly owned U.S. Application No. XX/XXX,XXX, entitled “Training Data Generation by Bucketing Users based on Output of a Contextual Bandit Model” and filed on Dec. 21, 2023.

### BACKGROUND

Online systems provide content to users with which the users may interact using client devices. To select content to present to users, online systems generally rely on machine-learning models that are trained to predict likelihoods that users will interact with particular content items. For example, a content selection model may take user data and content item data as inputs and output a score that represents an affinity of the user for the content item. The online system may generate this score for a set of candidate content items and select which content item to present to a user based on the scores of the content items.

While machine-learning models can be very effective at solving the problem for which they have been trained, their efficacy decreases when applied in contexts outside of those for which the models have been trained. For example, if a machine-learning model has been trained to score content items for presentation to a user, the scores output by the machine-learning model may not accurately reflect the rates at which users will interact with content when the content items are presented together. This decreased accuracy is caused by the impact that presenting content together in a bundle has on influencing a user's choice in which content item they will interact with. Therefore, to effectively predict the performance of bundled content, an online system generally must train a new machine-learning model to make predictions in those contexts, which is costly and time consuming.

### SUMMARY

In accordance with one or more aspects of the disclosure, an online system generates training data for a content bundle scoring machine-learning model using scores generated by content selection models. To generate the training data, the online system generates a set of training examples based on instances where users are presented with content bundles, which are bundles of content items to be presented together. The online system receives user interactions with presented content bundles and labels the training examples based on the user interactions. The online system uses these labeled training examples to train a machine-learning model to score content bundles for presentation to a user.

To select which content bundles to present to users for the training examples, the online system accesses user data describing a user to which the online system may present a content bundle. The online system generates a content item score for each of a plurality of content items using a content selection model. A content item score is a score that represents a likelihood that a user will interact with the content item if the content item is presented to a user. The content selection model is a machine-learning model that is trained to generate content item scores for users based on user data. The content selection model also may compute the content item scores based on content item data describing the content item and contextual data describing the context in which the content item may be presented to the user (e.g., session data describing the user's current session with the online system).

The online system generates a plurality of content bundles based on the plurality of content items. Each content bundle includes a subset of the plurality of content items, and may be generated based on a set of constraints for which content items can be included together in a content bundle. In some embodiments, the set of generated content bundles covers the full set of possible combinations of the plurality of content items. The online system generates a bundle score for each bundle based on the content item scores of the content items in the bundle. In some embodiments, the online system computes a sum of the content item scores to generate the bundle score, though alternative embodiments may use weighted sums or more complex algorithms to compute bundle scores.

When the online system detects an opportunity to present a content bundle to a user, the online system uses the generated bundle scores for the content bundles to select a content bundle to present to a user. For example, the online system may randomly select one of the content bundles, where the probabilities that each content bundle is picked is based on the computed bundle scores. For example, the online system may sum the bundle scores together and assign a probability of selection to each content bundle based on the content bundle's score divided by the sum of the bundle scores. Thus, while the online system is more likely to pick content bundles with higher bundle scores, the online system still explores the performance of content bundles with lower bundle scores.

The online system generates the training data based on user interactions with presented content bundles. For example, the online system may generate a training example that comprises the user data for the user to whom a content bundle was presented, content bundle data describing the content bundle (e.g., the content items in the content bundle), and a label indicating whether the user interacted with a content item in the presented content bundle. The online system may use these generated training examples to train a bundle selection model that is trained to predict a likelihood that a user will interact with a content item in a content bundle based on user data for the user and content bundle data associated with the content bundle.

The techniques described herein relate to a non-transitory computer-readable medium storing parameters for a bundle scoring machine-learning model. The system initializes the machine-learning model, and generates training examples. Training examples are generated by: accessing user data describing characteristics of a user, generating a content item score for each content item of a plurality of content items, generating the content item score includes applying a machine-learning model to the user data, generating a plurality of content bundles, generating a bundle score for each content bundle based on corresponding content item scores for the content item associated with each content bundle, and randomly selecting a bundle of the plurality of content bundles based on the generated bundle scores. The content item score represents a likelihood that the user will interact with the content item Each content bundle includes a subset of content items from the plurality of content items; The system transmits the randomly selected bundle to a client device associated with the user for display to the user, applies the model to each of the generated training examples, updates parameters of the model based on model output, and stores final parameters for the model to a computer-readable medium.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart for a method of generating training examples for a bundle scoring machine-learning model, in accordance with some embodiments.

FIG. 4 illustrates a diagram of the content item scores and content bundle scoring, in accordance with some embodiments.

FIG. 5 illustrates the selection of a content bundle, in accordance with some embodiments.

FIG. 6 illustrates an example user interface displaying a content bundle 610, in accordance with some embodiments.

### DETAILED DESCRIPTION

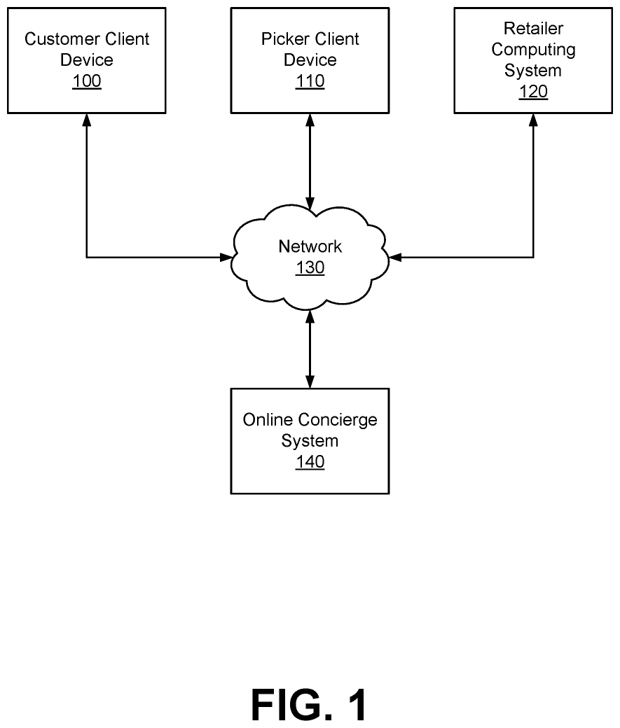

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provide portions of the payment from the user to the picker and the retailer.

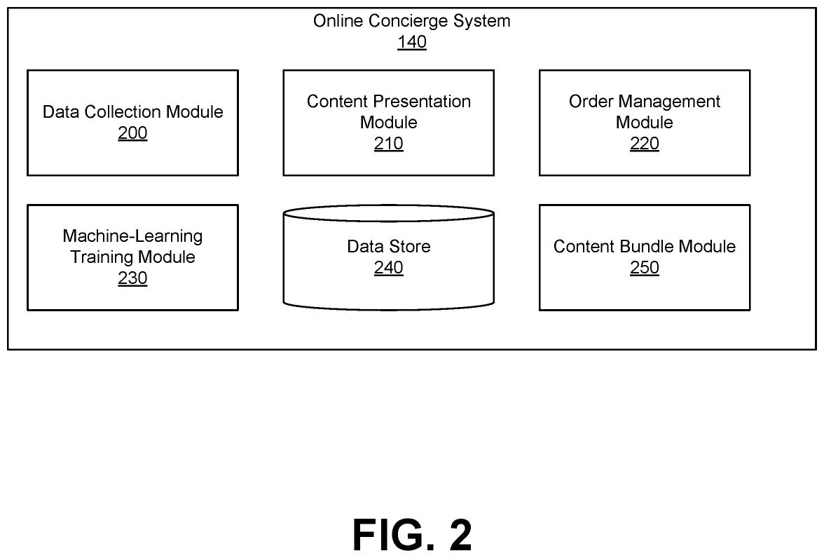

As an example, the online concierge system 140 may allow a user to order groceries from a grocery store retailer. The user's order may specify which groceries they want delivered from the grocery store and the quantities of each of the groceries. The user's client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a user based on whether the predicted availability of the item exceeds a threshold.

The order management module 220 that manages orders for items from users. The order management module 220 receives orders from a user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

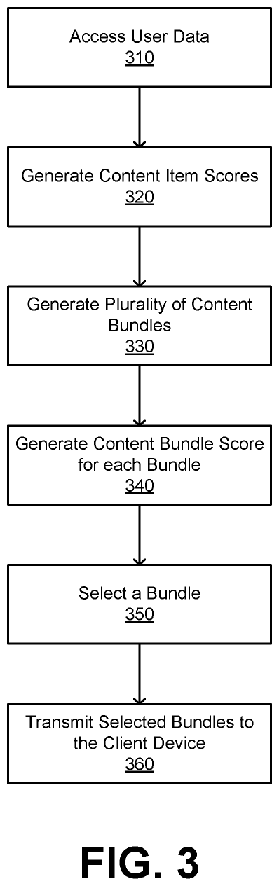

The content bundle module 250 generates the content item scores, bundles the content items into content bundles, and generates the content bundle score, as further discussed in FIG. 3.

FIG. 3 is a flowchart for a method of generating training examples for a bundle scoring machine-learning model, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 accesses 310 user data as collected by data collection module 200 from data store 240. User data may include user shopping history, purchase information, family account status and other information related to content items. As referred to herein, a “content item” is a piece of content provided to the user with an associated action. In some embodiments, content items are associated with a specification interaction that requires a specific associated action. For example, content items include notifications, messages, queries, videos, invitations, and coupon offers. Content item data, or data associated with the content item, includes records of the associated action, the behavior of a user in relation to the content item, and information regarding the proper display of the content item.

The online system generates 320 content item scores using a content selection model. A content selection model is a machine-learning model that is trained to generate content item scores for content items based on user data and data related to the content items. A content item score is a predicted performance of a content item according to some metric if the content item is presented to a user and so is based on a combination of a content item and user pair. The particular metric may vary depending on the variety of content. For example, metrics may include a rate of engagement, a completion rate, watch time, retention rate, conversation rate or other engagement metrics. The content selection model computes the content item score using the accessed user data. In some embodiments, the machine learning model computes the content item score using contextual data as well. The machine learning model is trained based on a set of training examples. The training examples include input data, such as user data from an instance where a user was presented with content, and as well as labels such as whether the user interacted with the content. The content bundle module 250 generates training examples using a testing process as the system presents content to the users. The presentation of content to the users may be done randomly or selected by a set policy or algorithm.

The content bundle module 250 generates 330 content bundles. As referred to herein, a “content bundle” is a set of content items to display together to a user. Each content bundle may have a set number of content items, or may have different numbers of content items in each content bundle. In some embodiments, content bundles are randomly generated by selecting from the plurality of content items. The plurality of content bundles generated may simply be that the system generates all possible combinations of content items, with each possible combination as a new content bundle. In some embodiments, the content bundles may be generated based on certain constraints. For example, the content bundles may be generated based on user preferences or history information associated with user data or may be set policies determined by the user regarding the content items of interest. The content bundles also may be generated based on constraints on the content items that can be included in a bundle, such as constraints on the types of content items that can be included in a bundle or how many content items can be included in a bundle. In some embodiments, content bundles include information that indicates descriptions of how the content items should be displayed, such as the order or relative position of the content item within the content bundle.

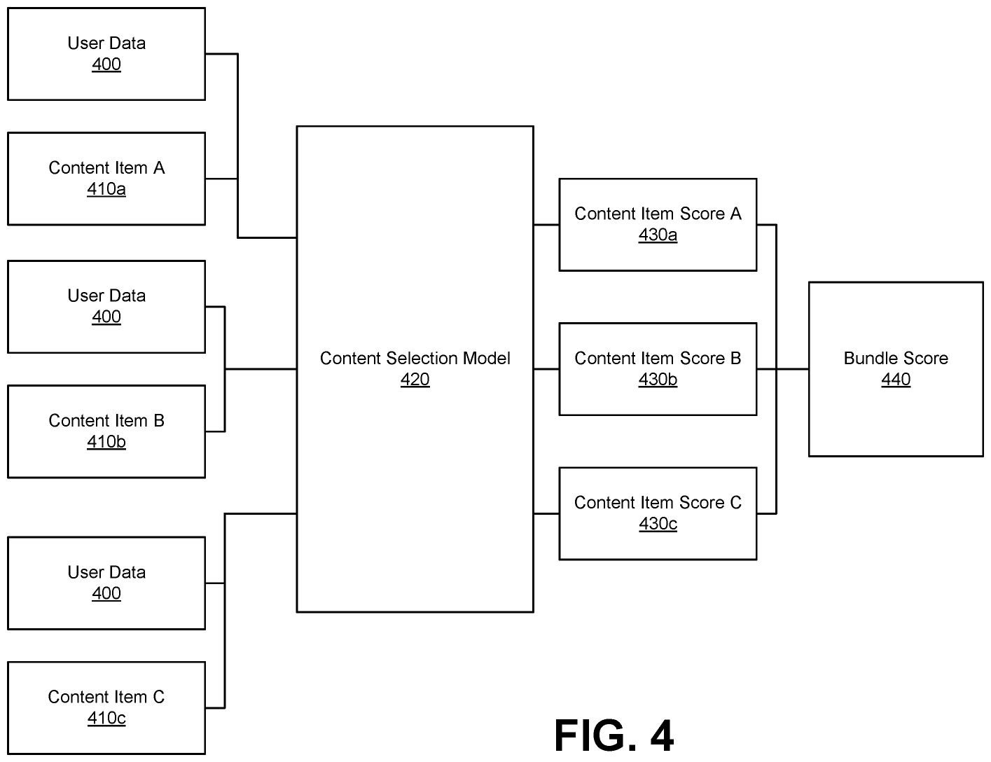

FIG. 4 illustrates a diagram of the content item scores and content bundle scoring, in accordance with some embodiments. The content selection model 420 receives, as inputs, user data 400 and content items 410 (e.g., content item A 410A, content item B 410B, and content item C 410C). The content selection model 420 outputs content item scores 430 (content item score A 430A, content item score B 430B, content item score C 430C) that correspond to each of the content items 410. As described above, the online system generates the content bundle score 440 based on the content item scores.

The content bundle module 250 generates 340 a content bundle score for each content bundle. A content bundle score represents a predicted performance of the content bundle. For example, a content bundle score may be the sum of the content item scores which, as noted above, may not directly reflect the actual performance of the content items when presented together as a content bundle. The online system may compute a weighted sum of the content item scores to focus on certain content items over others, based on a variety of factors such as type of content or the expected action or reward associated with the content. The weights used for the weighted sum of the content item scores may be dynamically adjusted based on feedback. The content bundle score may be based on an algorithm which considers the content item score as well as information about the user from the user data. In some embodiments, the online system uses a machine learning model to generate a bundle score based on the content item scores for the content items included in each bundle.

The content bundle module 250 selects 350 a content bundle of the generated content bundles to present to a user based on the generated content bundle scores. In some embodiments, the content bundle module 250 logs the chances of a selection of each content bundle and determines the probability distribution of content bundles. In some embodiments, the chance of sending each valid content bundle to the user is the content bundle score divided by the sum of all content bundle scores. The content bundle module 250 filters the generated content bundles for the valid content bundles. The validity of the bundles is based on whether all content within the bundles is still relevant and fit to be provided to the user. Invalid content bundles may be, for example, content bundles which include a content item that has a condition preventing it from presentation to the user or include content which is no longer relevant or has expired. In some embodiments, the content bundle module 250 logs the relevant chances of a selection of each content bundle for each content bundle.

In some embodiments, a non-content bundle is included in the selection process to increase the likelihood that no content bundle is shown over content bundles with low scores. In these embodiments, the selection of a non-content bundle means that no content bundle is shown, the non-content bundle is assigned a content bundle score to be used in the random selection process, and the content bundle module 250 may assign the non-content bundle a pre-determined score or may dynamically compute a score for the non-content bundle. For example, the content bundle module 250 may compute the content bundle score for a non-content bundle based on the content bundle scores of other content bundles, such as using a score that is greater than a median or mean content bundle score of others.

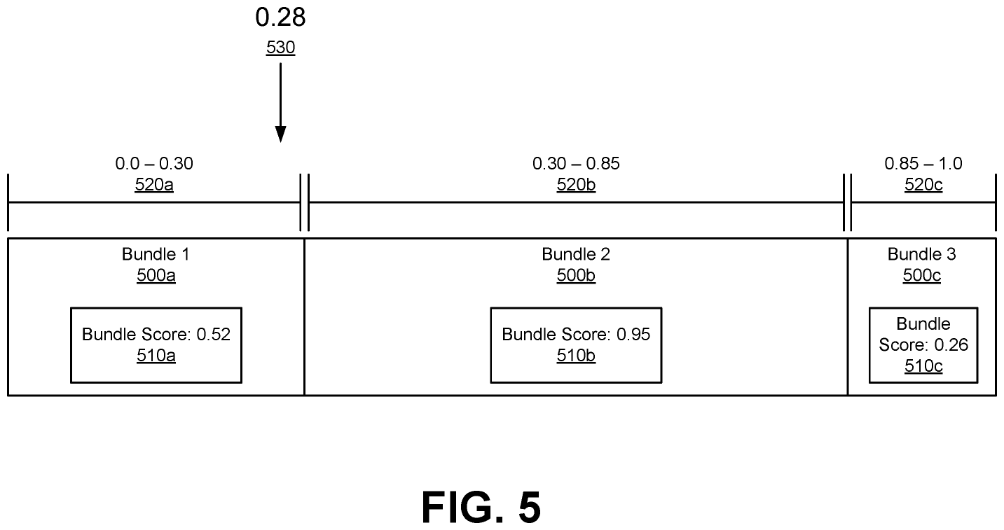

FIG. 5 illustrates the selection of a content bundle, in accordance with some embodiments. FIG. 5 shows three bundles 500, each with a computed content bundle score 510. As described above, the online system may generate a probability that each bundle will be selected based on the computed bundle scores 510 of all the candidate bundles. The online system may generate ranges 520 based on the calculated percentages and randomly select a number 530 within those ranges to select which bundle to present. The ranges 520 are computed based on the calculation of each bundle score 510 divided by the sum of all bundle scores 510. For example, range 520a is based on bundle score 510a divided by the sum of bund score 510a, bundle score 510b, and bundle score 530c. Here, Bundle 1 500a has a 30% chance to be selected, Bundle 2 500b has a 55% to be selected, and Bundle 3 500c has a 15% chance to be selected. This is because the sum of the bundle scores 510a, 510b, and 510c, is 1.73.

The content bundle module 250 transmits 360 selected content bundles to the client device. The training data based on these content bundle scores is used to train a content bundle scoring machine learning model, and takes advantage of the data already collected by the content selection model. The content bundle of content items is transmitted to a client device to display to a user. The content bundle module 250 may receive information on user interaction and create training information based on that interaction. The online concierge system generates training examples based on the user information and the interaction data. The training examples include input data such as user data, data on content items in the content bundle, content bundle data such as the order, and context data. The training examples also include labels such as whether the user interacted, and which content item was interacted with if any. The content bundle module 250 trains a machine learning model to predict performance of a content bundle if a content bundle is presented of a user. The performance may be the likelihood of interaction or expected return.

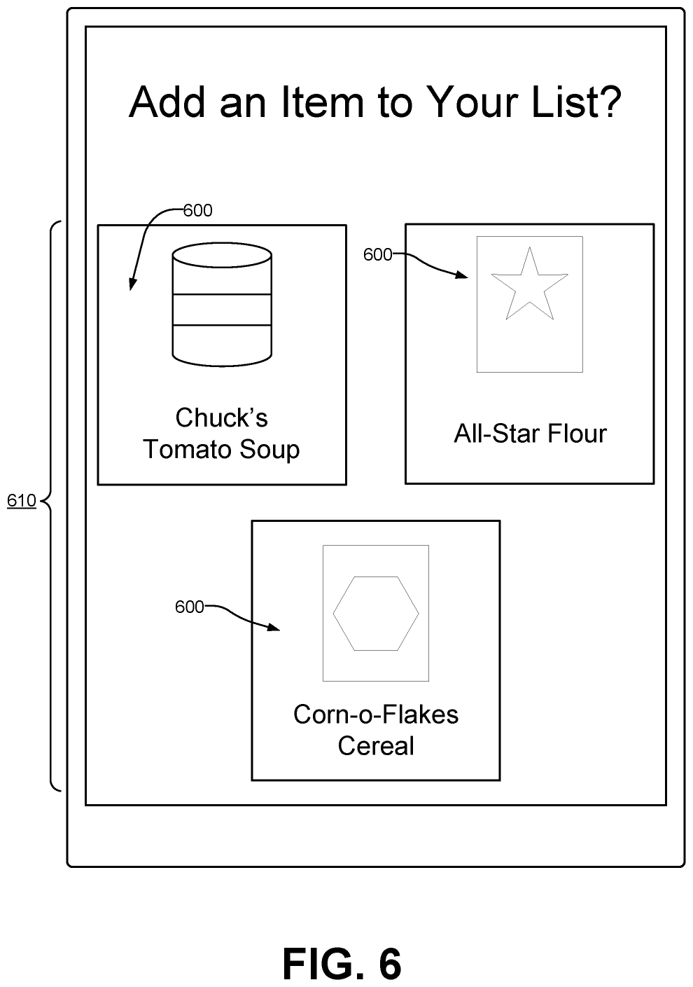

FIG. 6 illustrates an example user interface displaying a content bundle 610, in accordance with some embodiments. The content bundle 610 includes a set of content items 600 that are selected according to the process described above.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A non-transitory computer-readable medium storing parameters for a content bundle scoring model, wherein the parameters are produced by a process comprising:
initializing the content bundle scoring model, wherein the content bundle scoring model is a machine learning model;
generating a set of training examples for the content bundle scoring model by:
accessing user data describing characteristics of a user;
generating a content item score for each content item of a plurality of content items, wherein the content item score represents a likelihood that the user will interact with the content item, and generating the content item score comprises applying a content selection model to the user data, wherein the content selection model is a machine-learning model that is trained to generate content item scores for content items based on user data;
generating a plurality of content bundles, wherein each content bundle comprises a subset of content items from the plurality of content items;
generating, based on corresponding content item scores for the content item associated with each bundle and using the content selection model, a content bundle score for each content bundle;
randomly selecting, based on the generated bundle scores and using the content selection model, a content bundle of the plurality of content bundles; and
transmitting the randomly selected bundle to a client device associated with the user for display;
repeatedly re-training the content bundle scoring model by:
applying the content bundle scoring model to each of the generated training examples to generate an output for each training example; and
updating a set of parameters of the content bundle scoring model by applying a back propagation process to the content bundle scoring model based on the generated output for each training example; and
storing a final set of parameters for the content bundle scoring model to the computer-readable medium.

2. The non-transitory computer-readable medium of claim 1, wherein generating a plurality of content bundles further comprises:
generating an initial set of content bundles based on the plurality of content items; and
filtering the initial set of content bundles based on a set of constraints for generating content bundles.

3. The non-transitory computer-readable medium of claim 1, wherein generating the content item score for a content item further comprises:
accessing context data describing a context for displaying the content item to the user; and
generating the content item score based on the context data.

4. The non-transitory computer-readable medium of claim 1, wherein randomly selecting a content bundle of the plurality of content bundles based on the generated content bundle scores further comprises:
generating a probability distribution based on the generated content bundle scores; and
randomly selecting the content bundle of the plurality of content bundles based on the probability distribution.

5. The non-transitory computer-readable medium of claim 1, wherein the process further comprises:
receiving a user interaction with a content item of the selected content bundle through the client device;
generating a training example based on the content bundle and the user interaction; and
adding the training example to the set of training examples for the content bundle scoring model.

6. The non-transitory computer-readable medium of claim 1, wherein generating the content bundle score comprises generating a sum of all content item scores.

7. The non-transitory computer-readable medium of claim 1, wherein generating the plurality of content bundles comprises generating a non-content bundle that represents presenting no content bundle to the user.

8. The non-transitory computer-readable medium of claim 7, wherein generating a content bundle score for each content bundle further comprises:
generating a content bundle score for the non-content bundle based on content bundle scores for other content bundles in the plurality of content bundles.

9. A method comprising:
initializing a content bundle scoring model, wherein the content bundle scoring model is a machine learning model;
generating a set of training examples for the content bundle scoring model by:
accessing user data describing characteristics of a user;
generating a content item score for each content item of a plurality of content items, wherein the content item score represents a likelihood that the user will interact with the content item, and generating the content item score comprises applying a content selection model to the user data, wherein the content selection model is a machine-learning model that is trained to generate content item scores for content items based on user data;
generating, using the content selection model, a plurality of content bundles, wherein each content bundle comprises a subset of content items from the plurality of content items;
generating a content bundle score for each content bundle based on corresponding content item scores for the content item associated with each content bundle;
randomly selecting a content bundle of the plurality of content bundles based on the generated bundle scores; and
transmitting the randomly selected bundle to a client device associated with the user for display;
repeatedly re-training the content bundle scoring model by:
applying the content bundle scoring model to each of the generated training examples to generate an output for each training example; and
updating a set of parameters of the content bundle scoring model by applying a back propagation process to the content bundle scoring model based on the generated output for each training example; and
storing a final set of parameters for the content bundle scoring model to a computer-readable medium.

10. The method of claim 9, wherein generating a plurality of content bundles further comprises:
generating an initial set of content bundles based on the plurality of content items; and
filtering the initial set of content bundles based on a set of constraints for generating content bundles.

11. The method of claim 9, wherein generating the content item score for a content item further comprises:
accessing context data describing a context for displaying the content item to the user; and
generating the content item score based on the context data.

12. The method of claim 9, further comprising:
receiving a user interaction with a content item of the selected content bundle through the client device;
generating a training example based on the content bundle and the user interaction; and
adding the training example to the set of training examples for the content bundle scoring model.

13. The method of claim 9, wherein the plurality of content bundles includes a non-content bundle that represents presenting no content bundle to the user.

14. The method of claim 13, wherein generating a content bundle score for each content bundle further comprises:
generating a content bundle score for the non-content bundle based on content bundle scores for other content bundles in the plurality of content bundles.

15. A non-transitory computer-readable medium, the medium having encoded thereon a series of instructions for executing a process, the process comprising:
initializing a content bundle scoring model, wherein the content bundle scoring model is a machine learning model;
generating a set of training examples for the content bundle scoring model by:
accessing user data describing characteristics of a user;
generating a content item score for each content item of a plurality of content items, wherein the content item score represents a likelihood that the user will interact with the content item, and generating the content item score comprises applying a content selection model to the user data, wherein the content selection model is a machine-learning model that is trained to generate content item scores for content items based on user data;
generating a plurality of content bundles, wherein each content bundle comprises a subset of content items from the plurality of content items;
generating a content bundle score for each content bundle based on corresponding content item scores for the content item associated with each content bundle;
randomly selecting a content bundle of the plurality of content bundles based on the generated bundle scores; and
transmitting the randomly selected bundle to a client device associated with the user for display;
repeatedly re-training the content bundle scoring model by:
applying the content bundle scoring model to each of the generated training examples to generate an output for each training example; and
updating a set of parameters of the content bundle scoring model by applying a back propagation process to the content bundle scoring model based on the generated output for each training example; and
storing a final set of parameters for the content bundle scoring model to the computer-readable medium.

16. The non-transitory computer-readable medium of claim 15, wherein generating a plurality of content bundles further comprises:
generating an initial set of content bundles based on the plurality of content items; and
filtering the initial set of content bundles based on a set of constraints for generating content bundles.

17. The non-transitory computer-readable medium of claim 15, wherein generating the content item score for a content item further comprises:
accessing context data describing a context for displaying the content item to the user; and
generating the content item score based on the context data.

18. The non-transitory computer-readable medium of claim 15, wherein randomly selecting a content bundle of the plurality of content bundles based on the generated content bundle scores further comprises:
generating a probability distribution based on the generated content bundle scores; and
randomly selecting the content bundle of the plurality of content bundles based on the probability distribution.

19. The non-transitory computer-readable medium of claim 15, wherein the process further comprises:
receiving a user interaction with a content item of the selected content bundle through the client device;
generating a training example based on the content bundle and the user interaction; and
adding the training example to the set of training examples for the content bundle scoring model.

20. The non-transitory computer-readable medium of claim 15, wherein the plurality of content bundles includes a non-content bundle that represents presenting no content bundle to the user and wherein generating a content bundle score for each content bundle further comprises:
generating a content bundle score for the non-content bundle based on content bundle scores for other content bundles in the plurality of content bundles.
